(19) United States
(12) Patent Application Publication
(10) Pub. No.: US 2006/0130825 A1
(43) Pub. Date: Jun. 22, 2006

(54) Collapsible barbecue grill

(76) Inventor: Jui-Ju Yeh, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/017,351

(22) Filed: Dec. 20, 2004

(51) Int. Cl. F24B 3/00; A47J 37/00

(52) U.S. Cl. 126/25 R; 126/9 R

(57) ABSTRACT

A collapsible barbecue grill has a body, at least one primary bracket, a main support and a secondary support. The at least one primary bracket is mounted on the body. The main support is attached pivotally to the body, and the secondary support is attached pivotally to the main support. When the collapsible barbecue grill is used, the secondary support is held in the primary bracket to maintain the height of the collapsible barbecue grill. When the collapsible barbecue grill has to be stowed or moved, the secondary support is detached from the primary bracket and aligned with the main support.

### BACKGROUND OF THE INVENTION

1. Field of the Invention

The present invention relates to a barbecue grill, especially to a collapsible barbecue grill.

2. Description of the Prior Arts

Barbecue grills are used to roast food. A conventional barbecue grill comprises a body and a support assembly. The body is mounted on the support assembly to hold the body at a convenient and comfortable height for a person using the barbecue grill to cook. Mounting the body on the support assembly increases the volume of the barbecue grill. Moving the barbecue grill with larger volume is inconvenient. Conventional support assemblies on which the body is mounted cannot be collapsed. Therefore, stowing the barbecue grill is also inconvenient because the support cannot be collapsed to reduce the volume of the barbecue grill.

To overcome the shortcomings, the present invention provides a collapsible barbecue grill to mitigate or obviate the aforementioned problems.

### SUMMARY OF THE INVENTION

The main objective of the present invention is to provide a collapsible barbecue grill. The collapsible barbecue grill comprises a body, at least one primary bracket, a main support and a secondary support. The at least one primary bracket is mounted on the body. The main support is attached pivotally to the body, and the secondary support is attached pivotally to the main support. When the collapsible barbecue grill is used, the secondary support is held in the primary bracket to maintain the height of the collapsible barbecue grill. When the collapsible barbecue grill has to be stowed or moved, the secondary support is detached from the primary bracket and aligned with the main support.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a collapsible barbecue grill in accordance with the present invention;

FIG. 2 is an enlarged partial front view of the collapsible barbecue grill in FIG. 1;

FIG. 3 is an enlarged perspective view of a primary bracket of the collapsible barbecue grill in FIG. 1;

FIG. 4 is an enlarged perspective view of a secondary bracket of the collapsible barbecue grill in FIG. 1;

FIG. 5 is a front view of the collapsible barbecue grill in FIG. 1; and

FIG. 6 is a perspective view of the collapsible barbecue grill in FIG. 1 when the collapsible barbecue grill is collapsed.

### DETAILED DESCRIPTION OF THE PREFERRED EMBODIMENTS

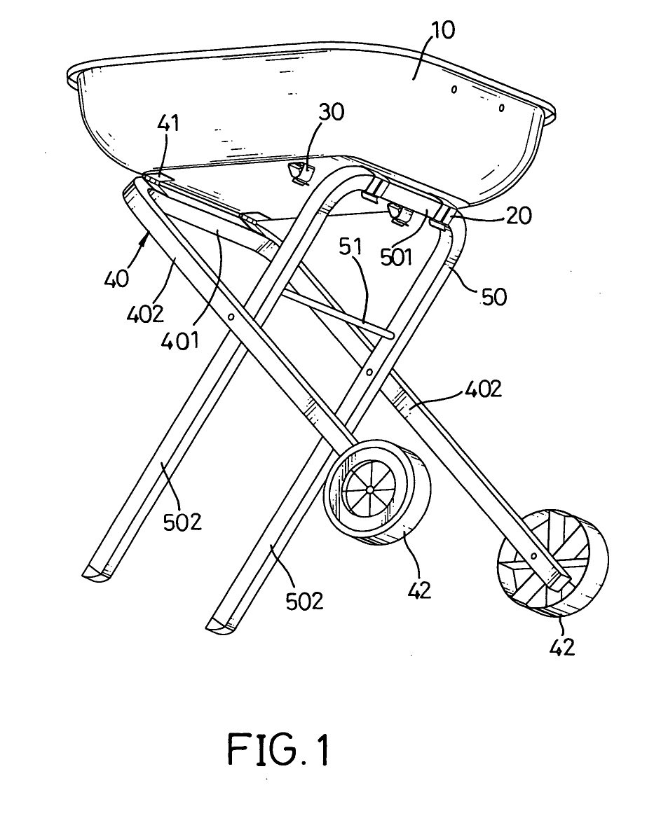

With reference to FIG. 1, a collapsible barbecue grill in accordance with the present invention comprises a body (10), at least one primary bracket (20), at least one optional secondary bracket (30), a main support (40) and a secondary support (50). In the preferred embodiment, the collapsible barbecue grill has two primary brackets (20) and two secondary brackets (30).

The body (10) has a top, a bottom and two sides.

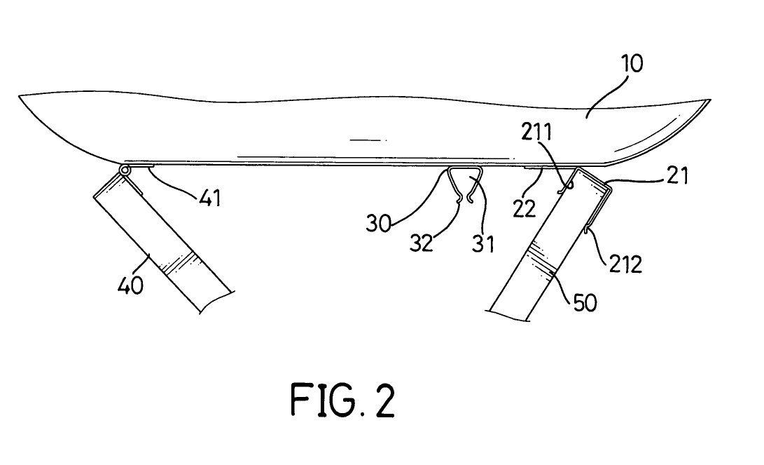

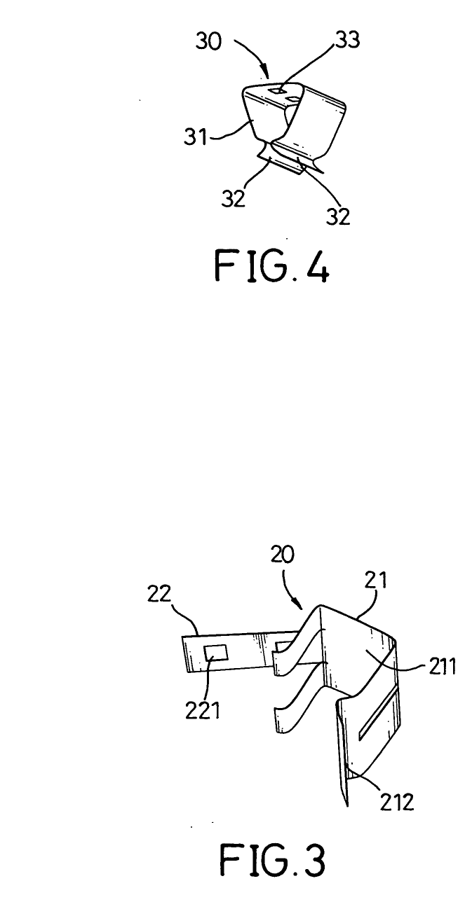

With further reference to FIGS. 2 and 3, the at least one primary bracket (20) is mounted on the bottom near one of the two sides of the body (10). Each primary bracket (20) has a base (21) and may have a fastening tab (22) and two fasteners. The base (21) is U-shaped and has an inner space (211), two ends and two limits (212). The limits (212) are formed respectively on the two ends and are formed inwardly toward the inner space (211). The fastening tab (22) is formed on and extends out from the base (21) and has two fastening holes (221). The two fasteners extend respectively through the two fastening holes (221) to attach the primary bracket (20) to the bottom of the body (10).

With further reference to FIG. 4, the at least one secondary bracket (30) is attached to the bottom of the body (10). Each secondary bracket (30) is V-shaped and has an inner space (31), two ends, an attached surface, two limits (32), two fastening holes (33) and two fasteners. The two limits (32) are formed respectively on the two ends and are formed inwardly toward the inner space (31). The two fastening holes (33) are formed through the attached surface. The two fasteners extend respectively through the two fastening holes (33) to attach the secondary bracket (30) to the bottom of the body (10).

The main support (40) is attached pivotally to the bottom of the body (10) near the side opposite to the primary bracket (20), may be U-shaped and may have a transverse rod (401), two longitudinal rods (402), two hinges (41) and two rollers (42). The transverse rod (401) is attached pivotally to the bottom of the body (10) near the side opposite to the primary bracket (20) and has two ends. The two longitudinal rods (402) are formed respectively on and extend perpendicularly from the two ends of the transverse rod (401), and each longitudinal rod (402) has a distal end and an inner side. The two hinges (41) are attached to the transverse rod (401) and the bottom of the body (10) to attach the transverse rod (401) pivotally to the bottom of the body (10). The two rollers (42) are mounted rotatably on the longitudinal rods (42) respectively near the distal ends of the longitudinal rods (42).

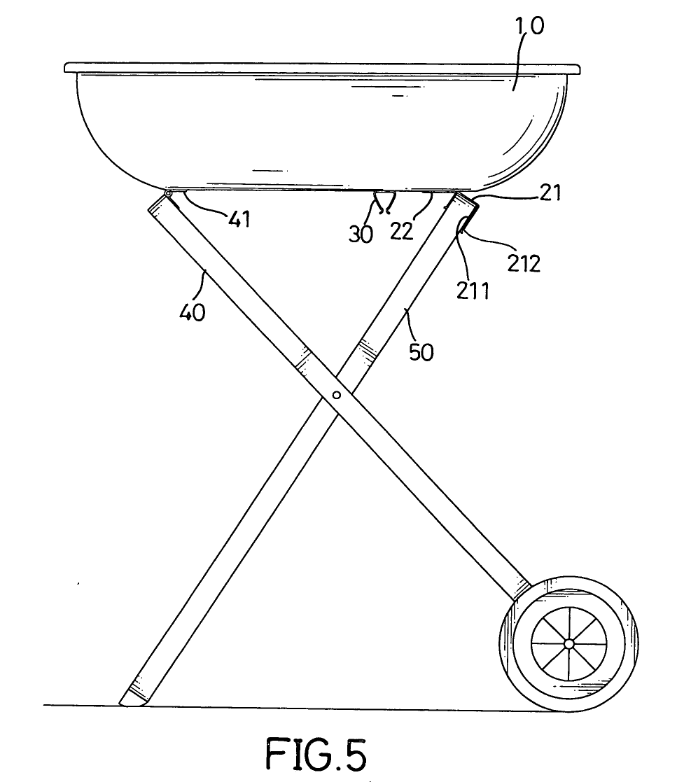

With further reference to FIG. 5, the secondary support (50) is attached pivotally to the main support (40), is selectively held in the inner space (211) of the at least one primary bracket (20), may be U-shaped and may have a transverse rod (501), two longitudinal rods (502) and a storage rod (51). The transverse rod (501) is held selectively in the inner space (211) and clamped by the limits (212) of the at least one primary bracket (20), has two ends and may be shorter than the transverse rod (401) of the main support (40). The longitudinal rods (502) are formed respectively on and extend perpendicularly from the two ends of the transverse rod (501), are attached pivotally to the inner side of the longitudinal rods (402) of the main support (40) and may be shorter than the longitudinal rods (402) of the main support (40). Each longitudinal rod (502) has a distal end and an inner side. The storage rod (51) is mounted securely between the inner sides of the longitudinal rods (502) and is selectively held in the inner space (31) and clamped by the limits (32) of the secondary bracket (30) when the supports (40, 50) are folded for storage.

When the collapsible barbecue grill is used, the transverse rod (501) of the secondary support (50) is held in the at least one primary bracket (20) and the limits (212) clamp the transverse rod (501) to maintain a stable included angle between the primary and secondary supports (40, 50). The rollers (42) on the longitudinal rods (402) of the main support (40) and distal ends of the longitudinal rods (502) of the secondary support (50) contact the ground to support the body (10) of the collapsible barbecue grill.

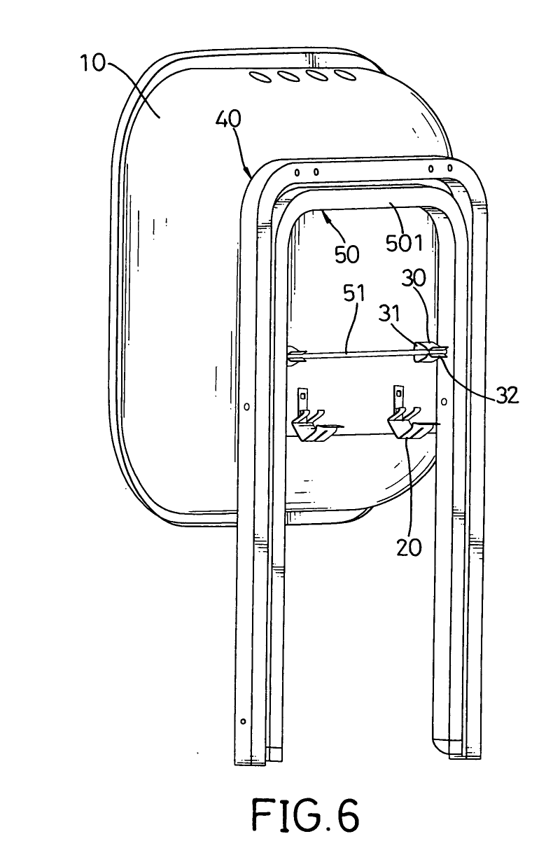

With further reference to FIG. 6, the collapsible barbecue grill is collapsed when the collapsible barbecue grill is stowed or moved. The transverse rod (501) of the secondary support (50) is detached from the inner space (211) of the at least one primary bracket (21). The secondary support (50) between the inner sides of the longitudinal rods (402) of the main support (40) is aligned with the main support (40). The storage rod (51) is held in the inner space (31) of the at least one secondary bracket (30), and the limits (32) clamp the storage rod (51) to hold the supports (40, 50) in position.

The collapsible barbecue grill as described has numerous advantages. The secondary support (50) is clamped easily in the inner spaces (211) of the at least one primary bracket (20) to maintain the height of the collapsible barbecue grill when the collapsible barbecue grill is used. When the collapsible barbecue grill has to be stowed or moved, the collapsible barbecue grill is stowed or moved easily because the supports (40, 50) can be folded to occupy a smaller volume.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A collapsible barbecue grill comprising
a body having a top, a bottom and two sides;
at least one primary bracket mounted on the bottom near one of the two sides of the body, and each primary bracket having
a base being U-shaped and having
an inner space;
two ends; and
two limits formed respectively on the two ends and formed inwardly toward the inner space;
a main support attached pivotally to the bottom of the body near the side opposite to the primary bracket; and
a secondary support attached pivotally to the main support and selectively held in the inner space of the at least one primary bracket.

2. The collapsible barbecue grill as claimed in claim 1, wherein
the main support is U-shaped and has
a transverse rod attached pivotally to the bottom of the body near the side opposite to the primary bracket and having two ends;
two longitudinal rods formed respectively on and extend perpendicularly from the two ends of the transverse rod, and each longitudinal rod has a distal end and an inner side; and
two hinges attached to the transverse rod and the bottom of the body to attach the transverse rod pivotally to the bottom of the body; and
the secondary support is U-shaped and has
a transverse rod held selectively in the inner space and clamped by the limits of the at least one primary bracket and having two ends; and
two longitudinal rods formed respectively on and extend perpendicularly from the two ends of the transverse rod and attached pivotally to the inner side of the longitudinal rods of the main support, and each longitudinal rod having a distal end and an inner side.

3. The collapsible barbecue grill as claimed in claim 2, wherein
the transverse rod of the secondary support is shorter than the transverse rod of the main support; and
the longitudinal rods of the secondary support are shorter than the longitudinal rods of the main support.

4. The collapsible barbecue grill as claimed in claim 2, wherein
the collapsible barbecue grill further comprises at least one secondary bracket attached to the bottom of the body, and each secondary bracket being V-shaped and having
an inner space;
two ends;
an attached surface; and
two limits formed respectively on the two ends and formed inwardly toward the inner space; and
the secondary support further having a storage rod mounted securely between the inner sides of the longitudinal rods and held selectively in the inner space and clamped by the limits of the secondary bracket.

5. The collapsible barbecue grill as claimed in claim 3, wherein
the collapsible barbecue grill further comprises at least one secondary bracket attached to the bottom of the body, and each secondary bracket being V-shaped and having
an inner space;
two ends;
an attached surface; and
two limits formed respectively on the two ends and formed inwardly toward the inner space; and
the secondary support further has a storage rod mounted securely between the inner sides of the longitudinal rods and held selectively in the inner space and clamped by the limits of the at least one secondary bracket.

6. The collapsible barbecue grill as claimed in claim 4, wherein
each primary bracket further comprises
a fastening tab formed on and extending out from the base and having two fastening holes for two fasteners to extend respectively through the two fastening holes to mount the primary bracket on the bottom of the body; and
each secondary bracket further comprises
two fastening holes formed through the attached surface for two fasteners to extend respectively through the two fastening holes to attach the secondary bracket to the bottom of the body.

7. The collapsible barbecue grill as claimed in claim 5, wherein
each primary bracket further comprises
a fastening tab formed on and extending out from the base and having two fastening holes for two fasteners to extend respectively through the two fastening holes to mount the primary bracket on the bottom of the body; and
each secondary bracket further comprises
two fastening holes formed through the attached surface for two fasteners to extend respectively through the two fastening holes to attach the secondary bracket to the bottom of the body.

8. The collapsible barbecue grill as claimed in claim 2, wherein the main support further comprises two rollers rotatably mounted respectively on the longitudinal rods near the distal ends of the longitudinal rods.

9. The collapsible barbecue grill as claimed in claim 7, wherein the main support further comprises two rollers rotatably mounted respectively on the longitudinal rods near the distal ends of the longitudinal rods.
